(19) United States
(12) Patent Application Publication
(10) Pub. No.: US 2025/0095186 A1
(43) Pub. Date: Mar. 20, 2025

(54) RELATIVE POSE ESTIMATION AND DATA ADJUSTMENT OF MULTIPLE SENSORS

(71) Applicant: QUALCOMM Incorporated, San Diego, CA (US)

(72) Inventors: Bjoern Johansson, LINKÖPING (SE); Hagen Spies, Stockholm (SE)

(21) Appl. No.: 18/469,327

(22) Filed: Sep. 18, 2023

(51) Int. Cl. G06T 7/70; G01D 18/00; G06T 7/20

(52) U.S. Cl. CPC G06T 7/70; G01D 18/004; G06T 7/20

(57) ABSTRACT

For an object having a plurality of sensors, motion measurement data of a first sensor of a pair of sensors and motion measurement data of a second sensor of the pair of sensors is transformed into a common coordinate system. Residual data for the transformations of the motion measurement data of the pair of sensors is determined by applying a distance function to the transformations of the motion measurement data. This is repeated for all unique pairs of sensors including the first sensor, and the residual data for each pair of sensors is collected in a residual motion vector data. A relative pose for the first and second sensors is determined based on the residual motion vector data. Sensor data of the first and second sensors may be adjusted based at least in part on the relative pose.

### TECHNICAL FIELD

This disclosure relates to sensor data processing.

### BACKGROUND

Autonomous vehicles and semi-autonomous vehicles may use artificial intelligence (AI) and machine learning (ML) (e.g., deep neural networks (DNNs)) for performing various operations for operating, piloting, and navigating the vehicles. For example, DNNs may be used for object detection, lane and road boundary detection, safety analysis, drivable free-space analysis, control generation during vehicle maneuvers, and/or other operations. DNN-powered autonomous and semi-autonomous vehicles should be able to respond properly to an incredibly diverse set of situations, including interactions with emergency vehicles, pedestrians, animals, and a virtually infinite number of other obstacles.

For autonomous vehicles to achieve autonomous driving levels 3-5 (e.g., conditional automation (Level 3), high automation (Level 4), and full automation (Level 5)) the autonomous vehicles should be capable of operating safely in all environments, and without the requirement for human intervention when potentially unsafe situations present themselves. An ADAS uses multiple sensors and software to help vehicles ensure safety and reliability. In a multi-sensor platform on a moving vehicle the relative poses of the sensors with respect to each other will change over time due to vibrations, temperature changes, ageing and other external factors. The data from the sensors should be adjusted over time to ensure accuracy in sensor data, thereby promoting safe and reliable operation of the vehicle.

### SUMMARY

This disclosure describes techniques for a centralized approach to automatic extrinsic multi-sensor relative pose estimation and data adjustments (e.g., in a vehicle or robotics applications). The techniques described herein convert each sensor's individual motion to a common coordinate system and collectively optimize the relative pose parameters of the sensors based on loss (e.g., residual) functions expressed in that common coordinate system. Examples of sensors include ultrasonic sensors, radio detection and ranging (RADAR) sensors, Light Detection and Ranging (“LIDAR”), surround cameras, infrared cameras, and so on. An inoperable sensor (for example, a camera that is damaged or unavailable due to blockage, or otherwise unable to provide motion data), may be omitted from the adjustment processing of the data of the remaining sensors. In the common coordinate system, a distance function may be chosen based at least in part on a vehicle's geometry. Vehicle sensor information such as wheel ticks, inertial measurement unit (IMU) sensors or Global Positioning System (GPS) based motion (which is typically expressed in a specific coordinate system) may also be incorporated as a virtual sensor into the techniques described herein. Adjusting the data of the sensor's results in more accurate sensor data being generated for use in applications such as ADAS, which improves the safety and reliability of operation of a vehicle (or of robotics applications).

In an aspect, a method includes transforming, by a computing system for an object having a plurality of sensors, motion measurement data of a first sensor of a pair of sensors of the plurality of sensors and motion measurement data of a second sensor of the pair of sensors into a common coordinate system; determining, based at least in part on applying a distance function to the transformations of the motion measurement data of the pair of sensors, residual data for the transformations of the motion measurement data of the pair of sensors; repeating selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; determining a relative pose for the first and second sensors based at least in part on the residual motion vector data; and adjusting sensor data of the first and second sensors based at least in part on the relative pose.

In another aspect, an apparatus includes a plurality of sensors, a memory that stores instructions; and processing circuitry that executes the instructions to transform, for an object having a plurality of sensors, motion measurement data of a first sensor of a pair of sensors of the plurality of sensors and motion measurement data of a second sensor of the pair of sensors into a common coordinate system; determine, based at least in part on applying a distance function to the transformations of the motion measurement data of the pair of sensors, residual data for the transformations of the motion measurement data of the pair of sensors; repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; determine a relative pose for the first and second sensors based at least in part on the residual motion vector data; and adjust sensor data of the first and second sensors based at least in part on the relative pose.

In a further aspect, a non-transitory computer-readable storage medium comprising instructions, that when executed by processing circuitry of a computing system, cause the processing circuitry to transform, for an object having a plurality of sensors, motion measurement data of a first sensor of a pair of sensors of the plurality of sensors and motion measurement data of a second sensor of the pair of sensors into a common coordinate system; determine, based at least in part on applying a distance function to the transformations of the motion measurement data of the pair of sensors, residual data for the transformations of the motion measurement data of the pair of sensors; repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; determine a relative pose for the first and second sensors based at least in part on the residual motion vector data; and adjusting sensor data of the first and second sensors based at least in part on the relative pose.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example computing system that may perform the techniques of this disclosure.

FIG. 3 is a block diagram illustrating a sensor calibration processing environment in accordance with the techniques of this disclosure.

FIG. 4 is a flowchart illustrating an example method for sensor calibration processing in accordance with the techniques of this disclosure.

### DETAILED DESCRIPTION

An ADAS uses sensors and software to help a vehicle ensure safety and reliability during operation of the vehicle. In a moving vehicle having multiple sensors, the relative poses between the sensors will change over time due to vibrations, temperature changes, ageing and other external factors. As used herein, a position includes a location in three-dimensional (3D) space (e.g., using x, y, and z axes), a relative pose includes rotation and position/translation), and motion refers to temporal rotation and translation. To ensure capturing an accurate description of the surrounding scene as the vehicle is operated, it becomes beneficial to dynamically update the relative poses of the sensors. If the data of the sensors are not periodically adjusted with changes in their relative poses, inaccurate sensor data may be produced by the sensors and subsequently input to the ADAS. If the ADAS processes inaccurate sensor data, the safety and reliability of the vehicle may be degraded. If each sensor can measure the sensor's individual motion (for example, using visual odometry or an IMU), and all sensors are mounted on the same rigid body (e.g., the vehicle chassis), the relative poses (including position data and rotation/translation data) of the sensors may be determined from the observed individual motions. In robotics, determining the relative poses of a pair of sensors is often called hand-eye calibration. This two-sensor approach has also been adopted to the automotive use case. However, individually processing every pair of sensors is slow and as the number of sensors on a vehicle increases, the two-sensor approach becomes unworkable. The techniques described herein overcome such disadvantages by providing a generalized and efficient approach to sensor pose estimation and data adjustment in a multi-sensor setting.

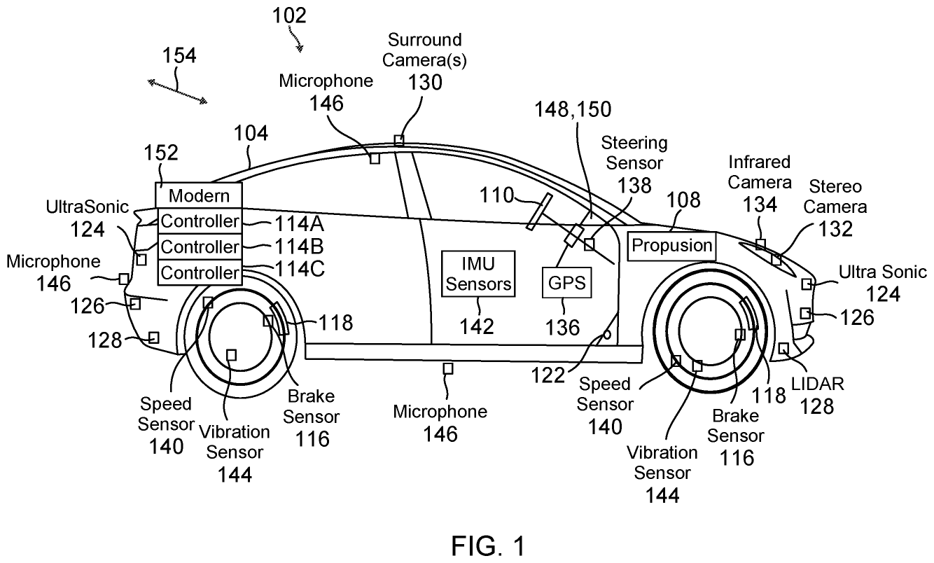

FIG. 1 is a diagram of an example autonomous vehicle, in accordance with the techniques of this disclosure. While described in relation to a vehicle, the techniques of this disclosure for automatic extrinsic sensor relative pose estimation and data adjustment may be used in any multi-sensor system, including aircraft, vehicles, robotics, extended reality (XR) systems, and the like. Autonomous vehicle 102 in the example shown may comprise any vehicle (such as a car or truck) that can accommodate a human driver and/or human passengers. Autonomous vehicle 102 may include a vehicle body 104 suspended on a chassis, in this example comprised of four wheels and associated axles. A propulsion system 108, such as an internal combustion engine, hybrid electric power plant, or even all-electric engine, may be connected to drive some or all the wheels via a drive train, which may include a transmission (not shown). A steering wheel 110 may be used to steer some or all the wheels to direct autonomous vehicle 102 along a desired path when the propulsion system 108 is operating and engaged to propel the autonomous vehicle 102. Steering wheel 110 or the like may be optional for Level 5 implementations. One or more controllers 114A-114C (e.g., a controller 114) may provide autonomous capabilities in response to signals continuously provided in real-time from an array of sensors, as described more fully below.

Each controller 114 may be one or more onboard computer systems that may be configured to perform deep learning and AI functionality and output autonomous operation commands to self-drive autonomous vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide AI functionality for in-camera sensors, and controller 114 (D (not shown in FIG. 1) may provide infotainment functionality and provide additional redundancy for emergency situations.

Controller 114 may send command signals to operate vehicle brakes (using brake sensor 116) via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”), a network inside modern vehicles used to control brakes, acceleration, steering, windshield wipers, and the like. The CAN bus may be configured to have dozens of nodes, each with its own unique identifier (CAN ID). The bus may be read to find steering wheel angle, ground speed, engine revolutions per minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be provided with dedicated hardware and software, allowing control of throttle, brake, steering, and shifting. The hardware may provide a bridge between the vehicle's CAN bus and the controller 114, forwarding vehicle data to controller 114 including the turn signals, wheel speed, acceleration, pitch, roll, yaw, GPS data, tire pressure, fuel level, sonar, brake torque, and others. Similar actuation controllers may be configured for any make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more radio detection and ranging (RADAR) sensors 126, one or more Light Detection and Ranging (“LIDAR”) sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle's path), one or more infrared cameras 134, GPS unit 136 that provides location coordinates, a steering sensor 138 that detects the steering angle, speed sensors 140 (one for each of the wheels), an inertial sensor or inertial measurement unit (IMU) 142 that monitors movement of vehicle body 104 (this sensor may be, for example, an accelerometer(s) and/or a gyro-sensor(s) and/or a magnetic compass(es)), tire vibration sensors 144, and microphones 146 placed around and inside the vehicle. Other sensors may also be used.

Controller 114 may also receive inputs from an instrument cluster 148 and may provide human-perceptible outputs to a human operator via human-machine interface (HMI) display(s) 150, an audible annunciator, a loudspeaker and/or other means. In addition to traditional information such as velocity, time, and other well-known information, HMI display may provide the vehicle occupants with information regarding maps and vehicle's location, the location of other vehicles (including an occupancy grid) and even the controller's identification of objects and status. For example, HMI display 150 may alert the passenger when the controller has identified the presence of a water puddle, stop sign, caution sign, or changing traffic light and is taking appropriate action, giving the vehicle occupants peace of mind that the controller is functioning as intended. In an aspect, instrument cluster 148 may include a separate controller/processor configured to perform deep learning and AI functionality.

Autonomous vehicle 102 may collect data that is preferably used to help train and refine the neural networks used for autonomous driving. The autonomous vehicle 102 may include modem 152, preferably a system-on-a-chip (SoC) that provides modulation and demodulation functionality and allows the controller 114 to communicate over the wireless network 154. Modem 152 may include a radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: long term evolution (LTE), wideband code division multiple access (WCDMA), universal mobile telecommunications framework (UMTS), global system for mobile communications (GSM), CDMA2000, or other known and widely used wireless protocols.

It should be noted that, compared to sonar and RADAR sensors 126, cameras 130 may generate a richer set of features at a fraction of the cost. Thus, autonomous vehicle 102 may include a plurality of cameras 130-134, capturing images around the entire periphery of the autonomous vehicle 102. Camera type and lens selection depends on the nature and type of function. The autonomous vehicle 102 may have a mix of camera types and lenses to provide complete coverage around the autonomous vehicle 102; in general, narrow lenses do not have a wide field of view but can see farther. All camera locations on the autonomous vehicle 102 may support interfaces such as Gigabit Multimedia Serial link (GMSL) and Gigabit Ethernet.

In an aspect, controller 114 may include at least a portion of an ADAS to perform automatic extrinsic relative pose estimation and data adjustment of multiple sensors (including cameras 130-134) in accordance with the techniques of this disclosure. For example, controller 114 may be configured to transform motion measurement data of a first sensor of a pair of sensors and motion measurement data of a second sensor of the pair of sensors into a common coordinate system. The controller 114 may be configured to determine, based at least in part on applying a distance function to the transformations of the motion measurement data of the pair of sensors, residual data for the transformations of the motion measurement data of the pair of sensors. The controller 114 may be configured to repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data. The controller 114 may be configured to determine a relative pose for the first and second sensors based at least in part on the residual motion vector data; and adjust data of the first and second sensors based at least in part on the relative pose.

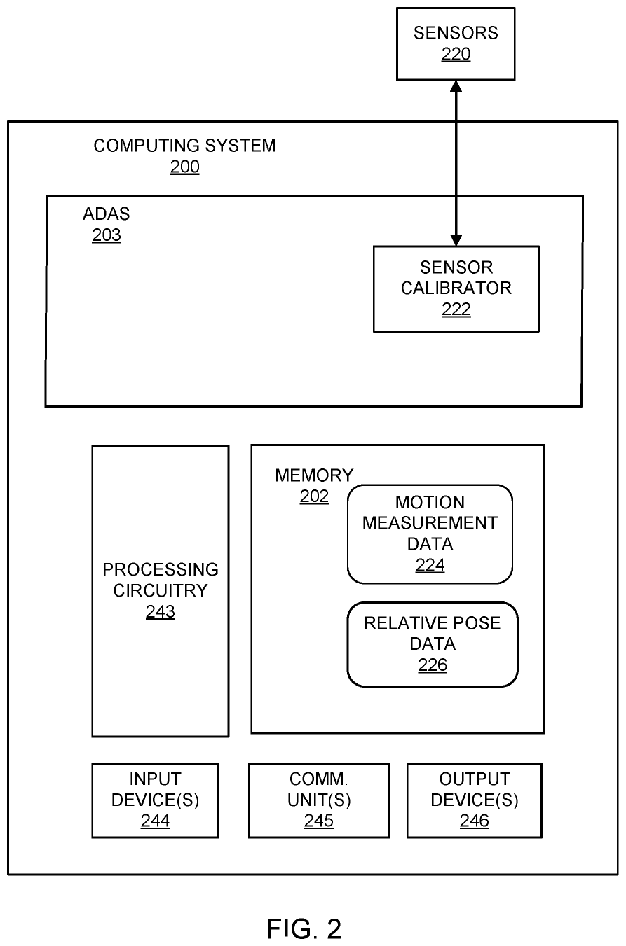

FIG. 2 is a block diagram illustrating an example computing system that may perform the techniques of this disclosure. As shown, computing system 200 comprises processing circuitry 243 and memory 202 for executing ADAS 203, which may represent an example instance of any controller 114 described in this disclosure, such as controller 114 of FIG. 1. In an aspect, ADAS 203 may include sensor calibrator 222. A plurality of sensors 220 may include any sensor in autonomous vehicle 102 as shown in FIG. 1, such as surround camera 130, stereo camera 132, infrared camera 134, steering sensor 138, ultrasonic sensors 124 and 126, LIDAR 128, brake sensor 116, vibration sensor 144, speed sensor 140, IMU sensors 142, and GPS 136. Other sensors may also be included in sensors 220. Although FIG. 1 shows autonomous vehicle 102 as a host of controller 114 (e.g., computing system 200), the techniques of this disclosure may be applied to any object (either movable or immovable) having a plurality of sensors 220 and sensor calibrator 222.

Each sensor may change over time in rotation angle (with three degrees of freedom) and in position/translation (with three degrees of freedom). These changes are denoted as motion measurement data 224 herein. The combination of rotation data and position data may be used to determine a relative pose 226 for each of sensors 220. Measurement motion data 224 and relative pose data 226 may be stored in memory 202.

In some cases, a sensor cannot estimate a magnitude/scale of translation, but only direction (that is, only two degrees of freedom). Sensors typically are unable to determine their absolute positions in the real world or their positions relative to the autonomous vehicle 102. Sensor calibrator 222 estimates the relative change in position in the real world for each sensor between a time k and k+1 (e.g., performs visual odometry), assuming that the real world is static/rigid. In other words, the rotation data and translation data (both parts of motion measurement data 224) do not define an absolute position for a sensor in the real world or in relation to the autonomous vehicle, but changes in the relative position of the sensor (the motion of the sensor) in the real world between times k and k+1. Determination of absolute positions may be accomplished by, for example, tracking local features or landmarks in camera images. Determining changes of relative positions over time for each sensor (motion) separately is sufficient to estimate the relative poses of the sensors with respect to each other.

Sensor calibrator 222 computes motion measurement data 224 (e.g., rotation data and position data). Sensor calibrator 222 processes motion measurement data 224 to generate relative pose data 226 as described below. In an aspect, the relative pose data 226 is relative to an origin of the common coordinate system. Sensor calibrator 222 may adjust data of the sensors based at least in part on relative pose data 226 of sensors 220. Adjusting the data produced by the sensors due to movement of the sensors results in more accurate sensor data being thereafter processed by ADAS 203, resulting in improved operation of autonomous vehicle 102. Sensor calibration processing may be performed automatically and periodically by sensor calibrator 222 for a plurality of sensors 220 in parallel.

In an implementation, the period may be any computationally suitable time frame, such as every half second, ever second, every two seconds, every five seconds, and so on.) In an aspect, relative pose data 226 may be generated for a selected or predetermined number of iterations before performing data calibration of sensors 220. The relative pose data 226 may be processed for the selected or predetermined number of iterations prior to data adjustment. For example, the relative pose data 226 from a combined number of iterations may be filtered and/or smoothed to overcome possible noise in any relative pose data 226. A relative pose may converge over the number of iterations to a desired end state, which may be used to continuously maintain accurate calibration of the data produced by sensors 220.

Computing system 200 may be implemented as any suitable external computing system accessible by controller 114, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store motion measurement data 224 received from sensors 220, as well as instructions of ADAS 203, including sensor calibrator 222, and relative pose data 226 generated by sensor calibrator 222.

Processing circuitry 243 and memory 202 may provide an operating environment or platform for one or more modules or units (e.g., ADAS 203, including sensor calibrator 222, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 203, including sensor calibrator 222, using virtualization modules, such as a virtual machine or container executing on underlying hardware. One or more of such modules may execute as one or more services of an operating system or computing platform. Aspects of ADAS 203, including sensor calibrator 222, may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

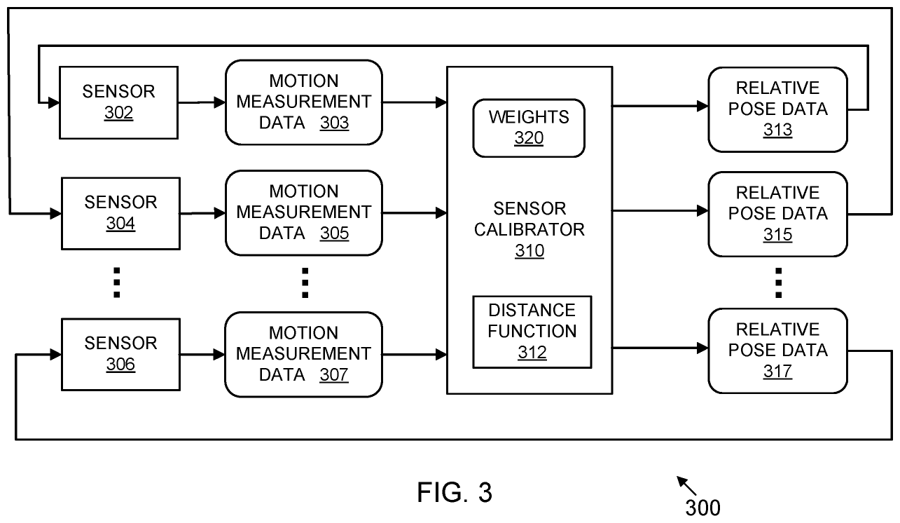

FIG. 3 is a block diagram illustrating a sensor calibration processing environment 300 in accordance with the techniques of this disclosure. A plurality of sensors 302, 304, . . . 306 may send, periodically and in parallel, motion measurement data (e.g., rotation data and position data) 303, 305, . . . 307, respectively, to sensor calibrator 310 (e.g., an instance of sensor calibrator 222 of FIG. 2). Sensors 302, 304, . . . 306 are examples of sensors 220 (e.g., surround camera 130, stereo camera 132, infrared camera 134, steering sensor 138, ultrasonic sensors 124 and 126, LIDAR 128, brake sensor 116, vibration sensor 144, speed sensor 140, IMU sensors 142, and GPS 136). Sensor calibrator 310 may automatically and periodically process the received motion measurement data (optionally in parallel), using distance function 312 (described further below) and weights 320, to generate relative pose data 313, 315, . . . 317, respectively, for the sensors. Relative pose data 313, 315, . . . 317, may be used to adjust the data of sensors 302, 304, . . . 306, as described below.

In a modern vehicle, such as autonomous vehicle 102, a plurality of sensors 220 are used to observe the surrounding real world and the relative placement of the sensors in ADAS 203 needs to be updated dynamically and periodically. As used herein, a relative pose (derived from motion measurement data 224 including rotation data and position data), of a sensor i is denoted herein as Xᵢ. In an aspect, the relative pose may be parameterized using a rotation matrix R^{p} and a translation vector tᵢ^{p} (the superscript p here denotes that the relative pose of the sensor is encoded in the vehicle coordinate system as opposed to the sensor's motion), as shown in Equation 1.

$${X}_{i} = ( \begin{matrix}{R}_{i}^{p} & {t}_{i}^{p} \\ {0}^{T} & 1\end{matrix} ) \qquad Equation 1$$

Note that other parameterizations may also be used, such as dual-quaternions or by expressing the rotation data in terms of rotation angles or regular quaternions. Using the same parameterization, the motion m (e.g., transformation in time) of sensor i may be encoded by Equation 2.

$${T}_{i} = ( \begin{matrix}{R}_{i}^{m} & {t}_{i}^{m} \\ {0}^{T} & 1\end{matrix} ) \qquad Equation 2$$

For any pair of sensors i and j, a hand-eye calibration problem includes estimating their relative pose (to each other) from their individual motions. Assuming the two sensors to be mounted on the same rigid body (such as autonomous vehicle 102), the motion of sensor j transformed to sensor i should equal the motion of sensor i, as shown in Equation 3.

$${T}_{i} = {X}_{i}^{- 1} {X}_{j} {T}_{j} {X}_{j}^{- 1} {X}_{i} \qquad Equation 3$$

Often only the relative pose X=X⁻¹ᵢXⱼ is of interest and the hand-eye equation becomes Equation 4.

$${T}_{i} X = {XT}_{j} \qquad Equation 4$$

The techniques of the present disclosure jointly and collectively estimate relative poses for a plurality of pairs of sensors, instead of treating individual sensor pairs separately as in existing approaches. Each measured motion m at time k is transformed into a common coordinate system (denoted herein by superscript c) as shown in Equation 5. In an aspect, the common coordinate system may be the vehicle coordinate system, a coordinate system of one of the sensors, or a coordinate system of another component of autonomous vehicle 102.

$${T}_{i , k}^{c} = {X}_{i} {T}_{i , k} {X}_{i}^{- 1} \qquad Equation 5$$

Since all transformed motions of sensors should be the same for all i (but potentially different for each k), the techniques described herein formulate a residual vector r (also known as a loss function) for a specific sensor pair i, j at a given observation time instance k as shown in Equation 6, with d(·) being a suitable distance function as described below.

$${r}_{i , j , k} = d ( {T}_{i , k}^{c} - {T}_{j , k}^{c} ) . \qquad Equation 6$$

Collecting transformations of all available pairs of sensors and all time instances (e.g., an open form solution) in a residual vector r allows for the application of a non-linear optimization process to solve for the Xᵢ that minimizes ∥r∥². Note that such a non-linear optimization process needs a start value that is close to the optimal solution or close enough (for example, within approximately a few degrees and a few centimeters from the true values) that the optimization converges rather than gets stuck in a local minimum, but in the automotive setting this is readily available from nominal sensor mounting information.

If any of the sensors 220 are unable to provide motion measurement data 224, perhaps due to sensor failure or blockage, at any given time an inoperable sensor may be omitted from determination of the residual vector r.

In an aspect, the distance function measures the distance between relative poses between time instances k and k+1 of two sensors. Several known approaches have been used to compute the distance function. For example, the rotational and translational data may be processed separately. For rotational data, many such distance functions are known, such as angular, chordal, and quaternion distances. For translational data, the Euclidean distance is well suited. However, since rotations are measured in angular units (e.g., radians, degrees) and translations are measured in length units (e.g., meters, inches), combining the two parts (rotational and translational) may be problematic.

In an implementation, the relative poses of the sensors may be represented in a Special Euclidean Group in 3D (SE(3)) format. That is, a relative pose may be a rigid transform in 3D which has six degrees of freedom (three angles and three positions). For example, a 3D point X is transformed using a 3×3 rotation matrix R and a 3×1 translation vector t as R*X+t. Rotation matrix R and t may be combined into a 4×4 matrix T=[Rt; 0 0 0 1] such that R*X+t=T*[X; 1] where the 4×1 vector [X; 1] is the homogeneous representation of the 3D point.

In an aspect, a distance function on SE(3) motivated by the physics of moving bodies may be used. A weight (e.g., one of weights 320 of FIG. 3), applied to the translational data and a matrix weight, applied to the rotational data, may be based on object density p(x) (e.g., of the autonomous vehicle 102) and/or the characteristic length scale s of the object. Thus, different axes may be weighted differently. For example, a vehicle usually rotates much more around the vertical axis due to turning. The rotation around the other axes is typically due to breaking, uneven road or vibrations, and are often smaller values. A specific vehicle motion model is not used herein, but techniques of the disclosure generally use the vehicle's dimensions, since an elongated object is much easier to rotate along its longitudinal axis then along an orthogonal axis.

In an aspect, a distance function may be obtained using the weighted Frobenius norm as shown in Equation 7.

$$d ( A - B ) = {‖ A - B ‖}_{W} = trace [ ( A - B ) {W ( A - B )}^{T} ] \qquad Equation 7$$

with the weight being determined from the density as shown in Equation 8 and where A and B are two motions or relative poses.

$$W = ( \begin{matrix}J & 0 \\ {0}^{T} & m\end{matrix} ) and J = \int x {x}^{T} ρ ( x ) d x , m = \int ρ ( x ) d x \qquad Equation 8$$

The inertia matrix J captures the shape of the object to which the sensors are attached (being related to the moment of inertia tensor I=trace(J)I₃−J). For an isotropic object with characteristic length scale s the inertia matrix becomes J=ams²I₃, where a depends on the density concentration; for a solid sphere this will be a=⅕. This simple model may be easy to implement and for a typical autonomous vehicle 102 the characteristic length scale s is on the order of two to five meters (m).

Another simple model of autonomous vehicle 102 that may be used takes the elongated shape of the vehicle into consideration is a homogenous cuboid defined by width, height and length parameters. For such a model, the inertia matrix is shown in Equation 9.

$$J = \frac{m}{12} ( \begin{matrix}{length}^{2} & 0 & 0 \\ 0 & {width}^{2} & 0 \\ 0 & 0 & {height}^{2}\end{matrix} ) \qquad Equation 9$$

In principle, it may be possible to compute J using the actual density of the vehicle 102. However, since a simplified model may be used, which does not take any external forces or steering constraints into consideration, the benefit of using an actual density may be limited.

In addition to the weighting scheme described above, in an aspect a tunable factor βᵢ (which may be different for each sensor pair) may be used to give more influence to the rotational data or the positional data when determining a distance between relative poses as shown in Equation 10.

$$W = ( \begin{matrix}J & 0 \\ {0}^{T} & β \cdot m\end{matrix} ) \qquad Equation 10$$

In a typical automotive scenario, sensors 220 are more sensitive to rotational errors and thus less emphasis may be put on the translational data by setting β<1 (for example β=½).

In an aspect, a robust re-weighting function ø (for example, the Huber influence function), may also be incorporated to modify the distance function: d (·)→ϕ(d(·)). Such a weight function decreases the influence of outliers and thus makes the estimate more stable if outliers are present.

Vehicles (such as autonomous vehicle 102) are often equipped with an intrinsic motion estimation capability based on various inputs such as steering angle, wheel tics, inertia sensors or GPS data. This ego-motion might not contain all degrees of freedom and could, for instance, only encode planar motion in the form of yaw-rate and forward speed. In an aspect, this motion information may be used as a virtual sensor providing motion measurement data 224 in the coordinate system in which this motion measurement data was originally provided. For front steered vehicles, this coordinate system is typically located at the center of the rear axle.

In an aspect, this ego-motion virtual sensor may be added to the plurality of sensors 220 being processed. In an implementation, only pairs of sensors with one of the pair being the ego-motion virtual sensor may be processed for determining relative poses, instead of pairing each sensor with all other (physical) sensors. This may reduce computational complexity and make adding or excluding sensors easier.

Some sensors 220 do not provide a scale of the motion translation, but only estimate the direction of translation (for example, monocular cameras using visual odometry). If one sensor provides a scale, in an implementation, the missing scale of another sensor may be estimated.

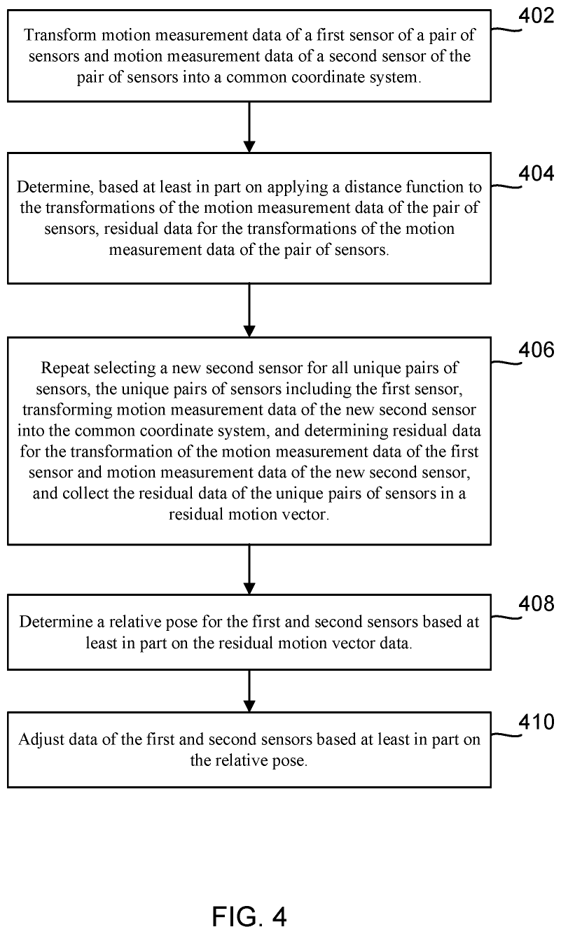

FIG. 4 is a flowchart illustrating an example method for sensor calibration processing in accordance with the techniques of this disclosure. Although described with respect to computing system 200 (FIG. 2), it should be understood that other computing devices may be configured to perform a method similar to that of FIG. 4.

At block 402, sensor calibrator 310 transforms motion measurement data (e.g., motion measurement data 303) of a first sensor (e.g., sensor 302) of a pair of sensors of autonomous vehicle 102 and motion measurement data (e.g., motion measurement data 305) of a second sensor (e.g., sensor 304) of the pair of sensors into a common coordinate system.

At block 404, sensor calibrator 310 determines, based at least in part on applying a distance function 312 to the transformations of the motion measurement data (e.g., motion measurement data 303, 305) of the pair of sensors (e.g., sensors 302, 304), residual data for the transformations of the motion measurement data of the pair of sensors. In an aspect, one or more weights 320 may be used in applying distance function 312.

At block 406, sensor calibrator 310 repeats selecting a new second sensor (e.g., sensor 306) from the plurality of sensors for all unique pairs of sensors, the unique pairs of sensors including the first sensor (e.g., sensor 302), transforming motion measurement data (e.g., motion measurement data 307) of the new second sensor into the common coordinate system, and determining residual data for the transformation of the motion measurement data (e.g., motion measurement data 303) of the first sensor (e.g., sensor 302) and motion measurement data (e.g., motion measurement data 307) of the new second sensor (e.g., sensor 306), and collects the residual data of the unique pairs of sensors in a residual motion vector data.

At block 408, sensor calibrator 310 determines a relative pose (e.g., relative pose data 313) for the first and second sensors (e.g., sensors 302, 304) based at least in part on the residual motion vector data.

At block 410, the data of the first and second sensors (e.g., sensors 302, 304) may be adjusted based at least in part on the relative pose of the first and second sensors (e.g., relative pose data 313, 315).

The actions of blocks 402 through block 410 may be repeated periodically for all sensors. In an aspect, the actions of blocks 402 through 410 may be performed for all sensors in parallel.

Thus, ADAS 203, using sensor calibrator 310, provides a mechanism to overcome changes in positions and rotations of sensors 302, 304, . . . 306 attached to autonomous vehicle 102 over time to improve the safety and reliability of operation of autonomous vehicle.

The following numbered clauses illustrate one or more aspects of the devices and techniques described in this disclosure.

Clause 1. A method including transforming, by a computing system for an object having a plurality of sensors, motion measurement data of a first sensor of a pair of sensors of the plurality of sensors and motion measurement data of a second sensor of the pair of sensors into a common coordinate system; determining, based at least in part on applying a distance function to the transformations of the motion measurement data of the pair of sensors, residual data for the transformations of the motion measurement data of the pair of sensors; repeating selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; determining a relative pose for the first and second sensors based at least in part on the residual motion vector data; and adjusting sensor data of the first and second sensors based at least in part on the relative pose.

Clause 2. The method of clause 1, wherein adjusting the data of the first sensor further includes adjusting the data of the first sensor in response to repeating determining, for a plurality of times, the relative pose for the first sensor.

Clause 3. The method of clause 1, wherein determining the relative posea for the first and second sensors includes performing non-linear optimization to minimize an absolute value of the residual motion vector data squared.

Clause 4. The method of clause 1, wherein applying the distance function includes determining a distance between a motion of the first sensor and a motion of the second sensor in the common coordinate system.

Clause 5. The method of clause 1, wherein the motion measurement data includes rotation data and position data of the first and second sensors in the common coordinate system.

Clause 6. The method of clause 5, further including applying weight data to at least one of the rotation data and the position data.

Clause 7. The method of clause 6, wherein the weight data includes inertia matrix data modeling a shape of the object.

Clause 8. The method of clause 6, further including generating the weight data based at least in part on a mass density of the object.

Clause 9. The method of clause 1, wherein one of the plurality of sensors includes a virtual sensor based at least in part on motion measurement data of the object in the common coordinate system.

Clause 10. The method of clause 9, wherein the unique pairs of sensors include the virtual sensor.

Clause 11. The method of clause 1, wherein the relative pose is relative to an origin of the common coordinate system.

Clause 12. The method of clause 1, further including, in response to the new second sensor being unable to provide motion measurement data, omitting selecting the new second sensor unable to provide motion measurement data from the plurality of sensors.

Clause 13. The method of clause 1, wherein the object comprises a vehicle.

Clause 14. An apparatus including a plurality of sensors, a memory that stores instructions; and processing circuitry that executes the instructions to transform, by a computing system for an object having a plurality of sensors, motion measurement data of a first sensor of a pair of sensors of the plurality of sensors and motion measurement data of a second sensor of the pair of sensors into a common coordinate system; determine, based at least in part on applying a distance function to the transformations of the motion measurement data of the pair of sensors, residual data for the transformations of the motion measurement data of the pair of sensors; repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; determine a relative pose for the first sensor based at least in part on the residual motion vector data; and calibrate sensor data of the first sensor based at least in part on the relative pose.

Clause 15. The apparatus of clause 14, further including the processing circuitry to execute instructions to determine the relative pose for the first and second sensors by performing non-linear optimization to minimize an absolute value of the residual motion vector data squared.

Clause 16. The apparatus of clause 14, wherein applying the distance function includes determining a distance between a motion of the first sensor and a motion of the second sensor in the common coordinate system.

Clause 17. The apparatus of clause 14, wherein the motion measurement data includes rotation data and position data of the first sensor in the common coordinate system.

Clause 18. A non-transitory computer-readable storage medium including instructions, that when executed by processing circuitry of a computing system, cause the processing circuitry to transform, by a computing system for an object having a plurality of sensors, motion measurement data of a first sensor of a pair of sensors of the plurality of sensors and motion measurement data of a second sensor of the pair of sensors into a common coordinate system; determine, based at least in part on applying a distance function to the transformations of the motion measurement data of the pair of sensors, residual data for the transformations of the motion measurement data of the pair of sensors; repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; determine a relative pose for the first and second sensors based at least in part on the residual motion vector data; and adjust sensor data of the first and second sensors based at least in part on the relative pose.

Clause 19. The non-transitory computer-readable storage medium of clause 18, wherein one of the plurality of sensors includes a virtual sensor based at least in part on motion measurement data of the object in the common coordinate system.

Clause 20. The non-transitory computer-readable storage medium of clause 18, wherein the relative pose is relative to an origin of the common coordinate system.

Clause 21. A computing system including means for performing any of the methods of Clauses 1 through 13.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
transforming, by a computing system for an object having a plurality of sensors, motion measurement data of a first sensor of a pair of sensors of the plurality of sensors and motion measurement data of a second sensor of the pair of sensors into a common coordinate system;
determining, based at least in part on applying a distance function to the transformations of the motion measurement data of the pair of sensors, residual data for the transformations of the motion measurement data of the pair of sensors;
repeating selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; and
determining a relative pose for the first and second sensors based at least in part on the residual motion vector data and adjusting sensor data of the first and second sensors based at least in part on the relative pose data.

2. The method of claim 1, wherein adjusting data of the first sensor further comprises adjusting the sensor data of the first sensor in response to repeating determining, for a plurality of times, the relative pose for the first sensor.

3. The method of claim 1, wherein determining the relative pose data for the first sensor comprises performing non-linear optimization to minimize an absolute value of the residual motion vector data squared.

4. The method of claim 1, wherein applying the distance function comprises determining a distance between a motion of the first sensor and a motion of the second sensor in the common coordinate system.

5. The method of claim 1, wherein the motion measurement data comprises rotation data and position data of the first sensor in the common coordinate system.

6. The method of claim 5, comprising applying weight data to at least one of the rotation data and the position data.

7. The method of claim 6, wherein the weight data comprises inertia matrix data modeling a shape of the object.

8. The method of claim 6, further comprising generating the weight data based at least in part on a mass density of the object.

9. The method of claim 1, wherein one of the plurality of sensors comprises a virtual sensor based at least in part on motion measurement data of the object in the common coordinate system.

10. The method of claim 9, wherein the unique pairs of sensors comprise the virtual sensor.

11. The method of claim 1, wherein the relative pose is relative to an origin of the common coordinate system.

12. The method of claim 1, further comprising, in response to the new second sensor being unable to provide motion measurement data, omitting selecting the new second sensor unable to provide motion measurement data from the plurality of sensors.

13. The method of claim 1, wherein the object comprises a vehicle.

14. An apparatus comprising:
a plurality of sensors;
a memory that stores instructions; and
processing circuitry that executes the instructions to:
transform, by a computing system for an object having a plurality of sensors, motion measurement data of a first sensor of a pair of sensors of the plurality of sensors and motion measurement data of a second sensor of the pair of sensors into a common coordinate system;
determine, based at least in part on applying a distance function to the transformations of the motion measurement data of the pair of sensors, residual data for the transformations of the motion measurement data of the pair of sensors;
repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; and
determine a relative pose for the first and second sensors based at least in part on the residual motion vector data and adjust sensor data of the first and second sensors based at least in part on the relative pose.

15. The apparatus of claim 14, further comprising the processing circuitry to execute instructions to determine the relative pose for the first sensor by performing non-linear optimization to minimize an absolute value of the residual motion vector data squared.

16. The apparatus of claim 14, wherein applying the distance function comprises determining a distance between a motion of the first sensor and a motion of the second sensor in the common coordinate system.

17. The apparatus of claim 14, wherein the motion measurement data comprises rotation data and position data of the first sensor in the common coordinate system.

18. A non-transitory computer-readable storage medium comprising instructions, that when executed by processing circuitry of a computing system, cause the processing circuitry to:
transform, by a computing system for an object having a plurality of sensors, motion measurement data of a first sensor of a pair of sensors of the plurality of sensors and motion measurement data of a second sensor of the pair of sensors into a common coordinate system;
determine, based at least in part on applying a distance function to the transformations of the motion measurement data of the pair of sensors, residual data for the transformations of the motion measurement data of the pair of sensors;
repeat selecting a new second sensor from the plurality of sensors for all unique pairs of sensors, the unique pairs of sensors including the first sensor, transforming motion measurement data of the new second sensor into the common coordinate system, and determining residual data for the transformation of the motion measurement data of the first sensor and motion measurement data of the new second sensor, and collecting the residual data of the unique pairs of sensors in a residual motion vector data; and
determine a relative pose for the first and second sensors based at least in part on the residual motion vector data and adjust sensor data of the first and second sensors based at least in part on the relative pose.

19. The non-transitory computer-readable storage medium of claim 18, wherein one of the plurality of sensors comprises a virtual sensor based at least in part on motion measurement data of the object in the common coordinate system.

20. The non-transitory computer-readable storage medium of claim 18, wherein the relative pose is relative to an origin of the common coordinate system.
